(19) United States
(12) Patent Application Publication
(10) Pub. No.: US 2005/0092127 A1
(43) Pub. Date: May 5, 2005

(54) Combination of bicycle headset assembly and head tube

(76) Inventor: Douglas Chiang, Ta-Li City (TW)

Correspondence Address: Mr. Phillip Liu, 6980, Whiteoak Dr., Richmond, BC, V7E 4Z9, CA

(21) Appl. No.: 10/695,985

(22) Filed: Oct. 30, 2003

(51) Int. Cl. B62K 21/12

(52) U.S. Cl. 74/551.8

(57) ABSTRACT

A headset assembly for a bicycle includes a bearing set engaged with an inner periphery of a top end of a head tube and an outer periphery of a positioning ring is engaged with an inner periphery of the bearing set. The inner periphery of the positioning ring is mounted on a steering tube. The head tube has a threaded outer periphery and a cap has a threaded inner periphery which is threadedly connected to the threaded outer periphery of the head tube.

### FIELD OF THE INVENTION

The present invention relates to a headset assembly for bicycle wherein a cap of the headset assembly is threadedly fixed to the head tube.

### BACKGROUND OF THE INVENTION

A conventional non-threaded bicycle headset assembly generally includes a steering tube which has smooth outer surface and extends through a head tube of the bicycle. The headset assembly is connected on each of two ends of the head tube and the steering tube rotatably extends through the headset assembly such that the steering tube can be rotated relative to the head tube by the headset assembly. A pressing member is mounted to a top end of the steering tube and an urging unit is forced fitting in the steering tube. A bolt is connected to the urging unit and a head of the bolt is engaged with a top end of the pressing member such that when rotating the bolt, the urging unit expands outward to securely connect the steering tube to the pressing member which is then moved downward to press on the headset assembly to position the bearing in the headset assembly.

Nevertheless, a special tool is required to hammer the urging unit into the steering tube and this takes a lot of time. Frequently, the urging unit is not forced into the steering tube as expected and this could affect the positioning of the headset assembly. Once the urging unit is deformed because of the hammering, it is difficult to take it out and this affects the time required when the headset assembly needs to be replaced with a new one.

### SUMMARY OF THE INVENTION

The present invention relates to a headset assembly for a bicycle and the headset assembly comprises a bearing set engaged with an inner periphery of a top end of a head tube and a positioning ring is engaged with an inner periphery of the bearing set. The positioning ring is mounted on a steering tube extending through the head tube. The head tube has a threaded outer periphery. A cap has a threaded inner periphery which is threadedly connected to the threaded outer periphery of the head tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the headset assembly and the head tube of the present invention;

FIG. 2 is a perspective view to show the combination of the headset assembly and the head tube of the present invention;

FIG. 3 shows the headset assembly connected to the head tube and the steering tube, and a handlebar stem is connected to the steering tube;

FIG. 4 is an enlarged view to show the headset assembly of the present invention;

FIG. 5 shows the cap of the head set assembly can be tightened or loosened by a wrench;

FIG. 6 shows another embodiment of the cap which can be tightened or loosened by another type of wrench;

FIG. 7 is an exploded view to show yet another embodiment the headset assembly and the head tube of the present invention;

FIG. 8 is a perspective view to show the combination of the headset assembly and the head tube of the present invention as shown in FIG. 7, and

FIG. 9 shows the headset assembly in FIG. 7 connected to the head tube and the steering tube, and a handlebar stem is connected to the steering tube.

### DETAILED DESCRIPTION OF THE PREFERRED EMBODIMENT

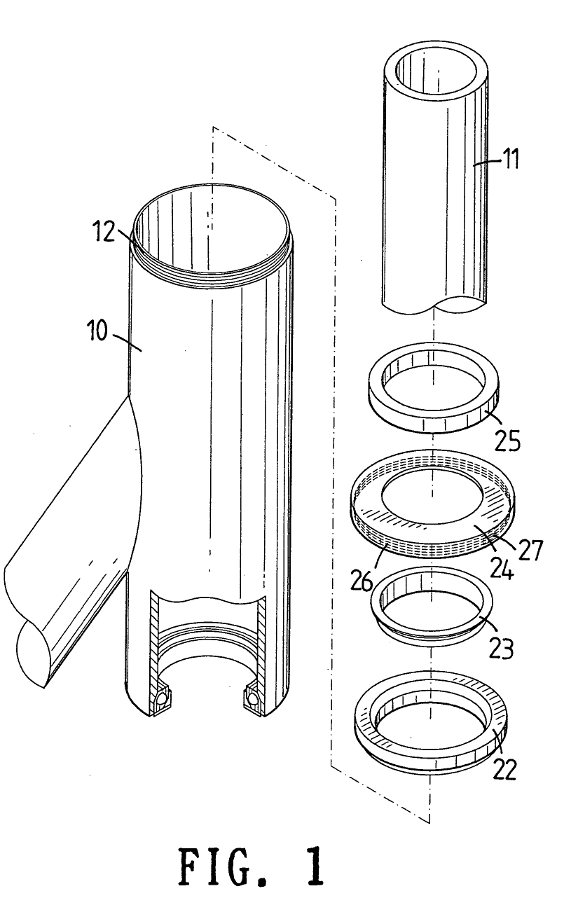

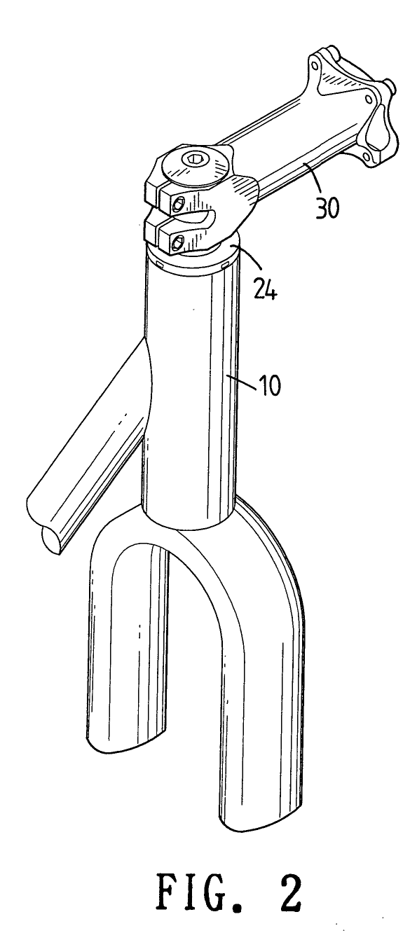

Referring to FIGS. 1 to 4, the headset assembly of the present invention is connected to a top end of the head tube 10 of a bicycle and comprises a bearing set 22 which is engaged with an inner periphery of the top end of the head tube 10. The inner periphery of the top end of the head tube 10 includes a tapered surface which matches with the tapered outer periphery of the bearing set 22. A positioning ring 23 has a tapered outer periphery which is engaged with a tapered inner periphery of the bearing set 22. The positioning ring 23 is mounted on a steering tube 11 which extends through the head tube 10 and a handlebar stem 30 is connected to the top end of the steering tube 11 extending out from the top end of the head tube 10. The head tube 10 has a threaded outer periphery 12. A cap 24 has a threaded inner periphery 26 which is threadedly connected to the threaded outer periphery 12 of the head tube 10. This allows the assemblers to easily connect the cap 24 to he head tube 10 and to position the bearing set 22. A pressing ring 25 is mount to the steering tube 11 and pressed by the handlebar stem 30 so as to presses on a top surface of the cap 24.

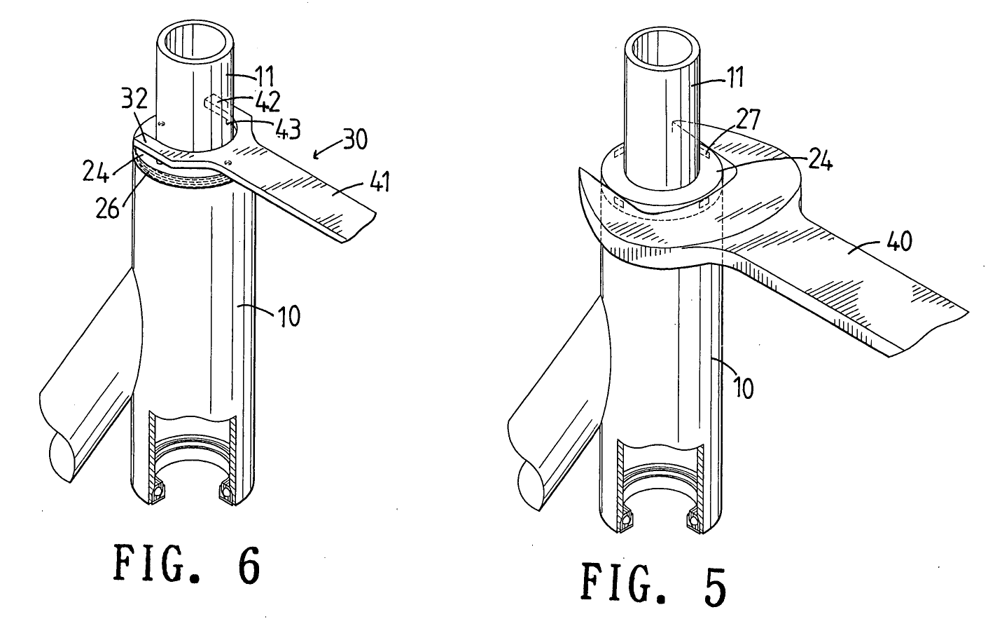

Further referring to FIG. 5, the cap 24 includes at least two flat surfaces 27 on an outer periphery thereof such that a wrench 40 can be easily rotate the cap 24 by clamping at the at least two flat surfaces 27.

Referring to FIG. 6, the cap 24 may have at least two holes defined in a top surface thereof and another type of wrench 41 has two protrusions 43 on the two jaws 42 such that the two protrusions 43 are inserted in the at least two holes so as to rotate the cap 24.

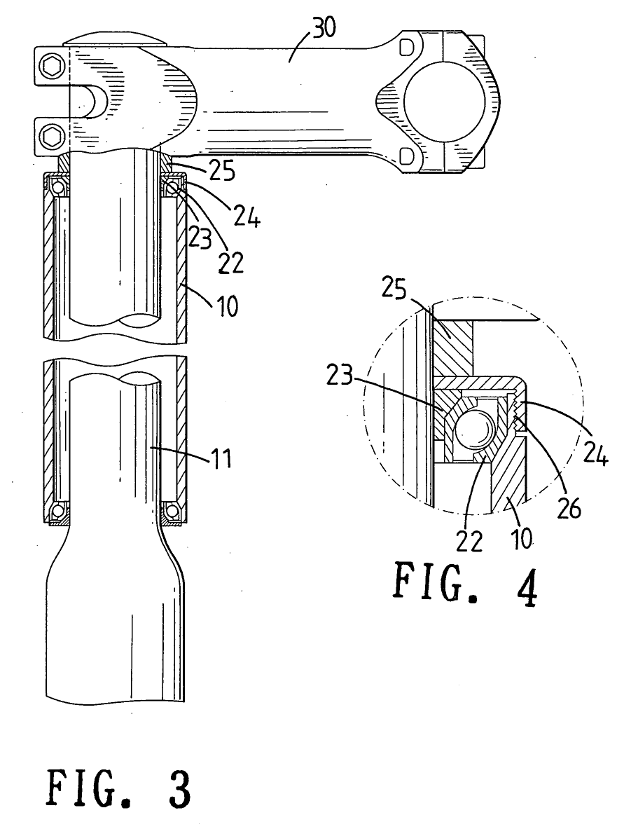

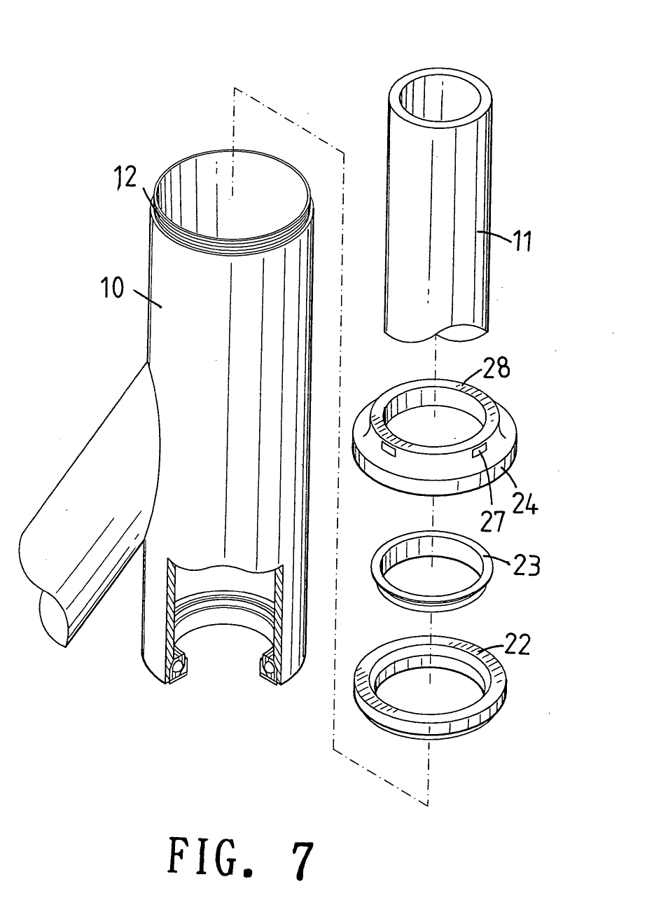

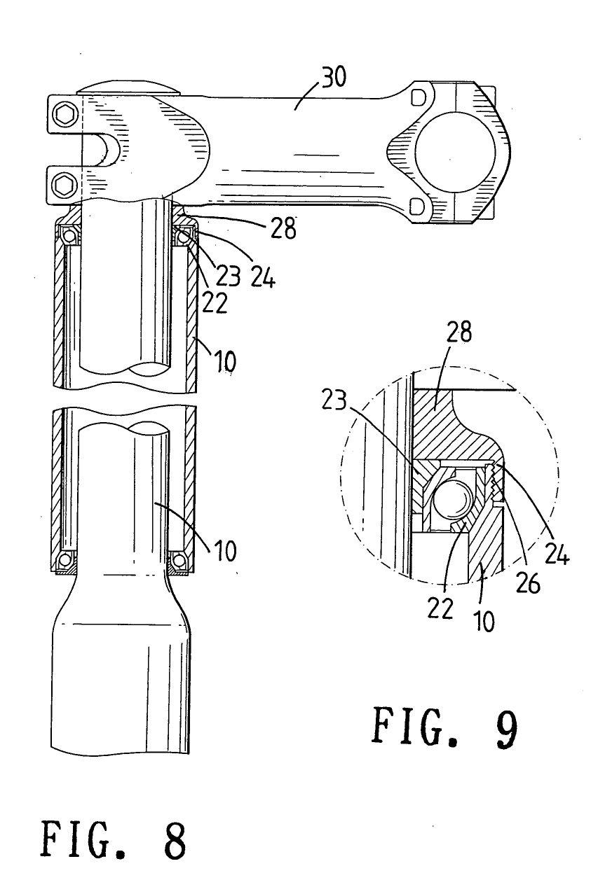

Referring to FIGS. 7 to 9, the cap 24 can be made to have a neck portion 28 which extends from a top side of the cap 24 so as to be pressed by the handlebar stem 30 and to replace the pressing ring as mentioned in FIGS. 3 and 4. The at least two flat surfaces 27 are defined in an outer periphery of the neck portion 28.

While we have shown and described the embodiment in accordance with the present invention, it should be clear to those skilled in the art that further embodiments may be made without departing from the scope of the present invention.

1. A headset assembly for a bicycle, comprising:
a bearing set engaged with an inner periphery of a top end of a head tube and a positioning ring engaged with an inner periphery of the bearing set, the positioning ring adapted to be mounted on a steering tube, the head tube having a threaded outer periphery, and
a cap having a threaded inner periphery which is threadedly connected to the threaded outer periphery of the head tube.

2. The headset assembly as claimed in claim 1, wherein the cap includes at least two flat surfaces on an outer periphery thereof.

3. The headset assembly as claimed in claim 1, wherein a pressing ring is adapted to mount to the steering tube and presses on a top surface of the cap.

4. The headset assembly as claimed in claim 1, wherein the cap has at least two holes defined in a top surface thereof.

5. The headset assembly as claimed in claim 1, wherein the inner periphery of the top end of a head tube is a tapered surface and an inner periphery of the bearing set is a tapered surface which matches with the tapered surface of the inner periphery of the top end of the head tube.
